(19) United States
(12) Patent Application Publication
(10) Pub. No.: US 2017/0358265 A1
(43) Pub. Date: Dec. 14, 2017

(54) DISPLAY DRIVER BACKPLANE, DISPLAY DEVICE AND FABRICATION METHOD

(71) Applicant: SHANGHAI JADIC OPTOELECTRONICS TECHNOLOGY CO., LTD., Shanghai (CN)

(72) Inventor: Xiaochuan WANG, Shanghai (CN)

(21) Appl. No.: 15/621,561

(22) Filed: Jun. 13, 2017

(30) Foreign Application Priority Data
Jun. 13, 2016 (CN) 201610420503.3

(51) Int. Cl. G09G 3/36; G09G 3/34

(52) U.S. Cl. CPC G09G 3/3655; G09G 3/3688; G09G 3/3677; G09G 3/3406

(57) ABSTRACT

A display driver backplane, a display device and a fabrication method thereof are disclosed. The display driver backplane includes: a first semiconductor laminate including pixel driver array consisting of a plurality of pixel driver elements and first peripheral circuit unit; first electrode array formed on second surface of first semiconductor laminate; a second semiconductor laminate containing a second peripheral circuit unit, wherein a first surface of the second semiconductor laminate is bonded to a first surface of first semiconductor laminate; and first vias that are formed within first semiconductor laminate and electrically interconnect first-electrode array and pixel-driver array. The present invention addresses prior-art issues of high difficulty in fabricating transistors with different capabilities in the same layer and costly interconnection between transistors in different chips by employing a technique in which two or three chips are stacked together, and hence achieves significant improvements in device performance and reductions in cost.

### CROSS-REFERENCES TO RELATED APPLICATIONS

This application claims the priority of Chinese patent application number 201610420503.3, filed on Jun. 13, 2016, the entire contents of which are incorporated herein by reference.

### TECHNICAL FIELD

The present invention relates to the field of display technology and, in particular, to a display driver backplane with a stack of multiple chips, a display device and a fabrication method.

### BACKGROUND

A micro display backplane is an active matrix display device integrating an active matrix of light-emitting diodes or spatial light modulation (SLM) pixel elements to an array corresponding to a pixel driver circuit and a peripheral circuit on a single substrate. Common light-emitting diodes and spatial light modulation pixel elements include LED, OLED, liquid crystal display (LCD) and MEMS optical modulators. MEMS optical modulators include digital micro-mirror devices and digital micro shutters. The pixel driver circuit and peripheral circuit are composed of semiconductor transistors, in which common thin film transistors are fabricated on a dielectric substrate such as a glass substrate, or MOS transistors are formed on a semiconductor substrate such as a silicon substrate.

In order to drive various light-emitting diodes or SLM pixel elements, the underlying pixel driver circuit typically requires MOS transistors adapted for high voltages and/or high currents. However, in the peripheral circuit, those for receiving data and signal or providing control signals usually employ low-voltage, high-speed MOS transistors. In addition, in order to enable a higher display resolution and frame rate, the peripheral circuit usually also requires high-speed, high-capacity on-chip memories as data buffers.

A system for driving such a micro display backplane needs to integrate sub-circuits that are of various functions and those sub-circuits usually employ a variety of MOS transistors. As a result, forming a system-on-chip architecture for the backplane driver system constructed from multiple sub-circuits composed of various MOS transistors on a single semiconductor substrate, particularly on the same silicon substrate, will not only impose a great challenge on but will also lead to great increases in the cost of the fabrication process, making the process complex or even infeasible. Additionally, integrating circuits of different functions on the same semiconductor substrate will also lead to an increase size and reduced performance, particularly a lower operational speed and higher power consumption, of a chip integrating such a micro display backplane driver system.

### SUMMARY OF THE INVENTION

It is an object of the present invention to provide a display driver backplane that can be fabricated simply and has better performance, comprising:

a first semiconductor laminate comprising a first surface and a second surface opposing the first surface, wherein the first semiconductor laminate comprises a first semiconductor chip including: a pixel driver array consisting of a plurality of pixel driver elements; and a first peripheral circuit unit for driving the pixel-driver array;

a first electrode array consisting of a plurality of first electrodes formed on the second surface of the first semiconductor laminate, wherein each of the plurality of first electrodes in the first-electrode array is connected to a corresponding one of the plurality of pixel driver elements in the pixel-driver array through at least one first via, and wherein the first-electrode array is connected to an external pixel display element array; and

a second semiconductor laminate comprising a first surface and a second surface opposing the first surface, wherein the second semiconductor laminate comprises a second semiconductor chip including: a second peripheral circuit unit, and wherein the first surface of the second semiconductor laminate is bonded to the first surface of the first semiconductor laminate.

The present invention also discloses a display device comprising the display driver backplane as defined above. The display device further comprises a display backplane electrically interconnected with the driver backplane, wherein the display backplane comprises a pixel display element array, and wherein the first-electrode array on the first semiconductor laminate of the display driver backplane is electrically interconnected with the pixel display element array of the display backplane.

The present invention also discloses a method for fabricating the display driver backplane as defined above, comprising the steps of:

providing a first semiconductor substrate comprising a first surface and a second surface opposing the first surface;

forming the pixel-driver array consisting of the plurality of pixel driver elements and the first peripheral circuit unit on the first semiconductor substrate, resulting in the first semiconductor laminate;

providing a second semiconductor substrate comprising a first surface and a second surface opposing the first surface

forming the second peripheral circuit on the second semiconductor substrate, resulting in the second semiconductor laminate;

bonding the first surface of the first semiconductor laminate to the first surface of the second semiconductor laminate;

polishing the second surface of the first semiconductor substrate to thin the semiconductor laminate;

forming the plurality of first vias in the first semiconductor laminate; and

forming a first-electrode array on the second surface of the first semiconductor laminate such that each of the plurality of first vias electrically interconnects a first electrode in the first-electrode array and a pixel driver element in the pixel-driver array.

Compared to the prior art, the display driver backplane of the present invention employs a technique in which two or three chips are stacked together, enabling placement of transistors with various capabilities in different layers, which are interconnected using a deep via technique, with electrodes disposed on the top layer driving and controlling the display panel. This addresses the prior-art issues of high difficulty in fabricating transistors with different capabilities in the same layer and costly interconnection between transistors in different chips, resulting in significant improvements in device performance and reductions in cost.

Therefore, in principle, the deficiencies of the aforesaid system-on-chip architecture may be resolved by a solution in which multiple chips are stacked together three-dimensionally, with sub-circuits of different MOS transistors fabricated by different processes being interconnected into a system using the via technology. The present invention just discloses such a solution in which multiple chips are three-dimensionally stacked to foul′ a micro display backplane driver system at low processing cost and high integration.

### BRIEF DESCRIPTION OF THE DRAWINGS

FIG. 1 is a structural schematic of a display driver backplane according to a first embodiment of the present invention.

FIG. 2 is a structural schematic of a driver backplane according to a second embodiment of the present invention.

FIG. 3 is a structural schematic of a driver backplane according to a third embodiment of the present invention.

FIG. 4 is a structural schematic of a display device according to the first embodiment of the present invention.

FIG. 5 is a flowchart illustrating a method for fabricating the display device driver backplane according to the first embodiment of the present invention.

FIGS. 6 to 12 are schematics showing the method for fabricating the display device driver backplane according to the first embodiment of the present invention.

### DETAILED DESCRIPTION

Active visible display devices and driver circuits thereof according to the present invention will be described in greater detail in connection with the schematic drawings. It is to be appreciated that those of skill in the art can make changes to the invention disclosed herein while still obtaining the beneficial results thereof. Therefore, the following description shall be construed as being intended to be understood by those skilled in the art rather than as limiting the invention. Note that the figures are provided in a very simplified form not necessarily presented to scale, with the only intention of facilitating convenience and clarity in explaining some embodiments of the invention.

First Embodiment of Display Driver Backplane

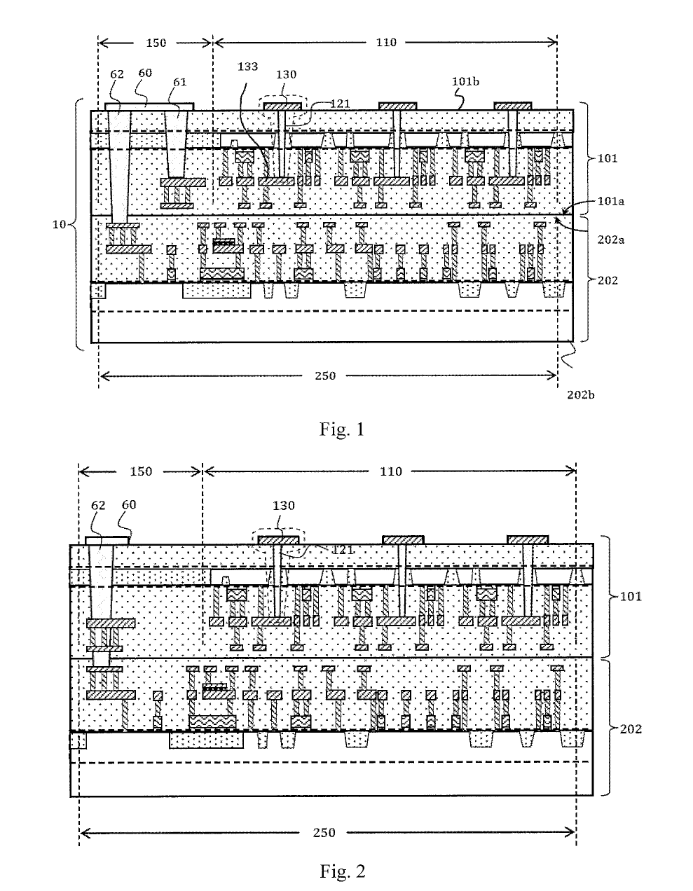

Referring to FIG. 1, a display driver backplane 10 according to this embodiment includes: a first semiconductor laminate 101 having a first surface 101a and a second surface 101b opposing the first surface, wherein a first semiconductor chip in the first semiconductor laminate 101 includes a pixel-driver array 110 consisting of a plurality of pixel driver elements and a first peripheral circuit unit 150; a first-electrode array 130 on the second surface 101b of the first semiconductor laminate; a second semiconductor laminate 202 having a first surface 202a and a second surface 202b opposing the first surface, wherein a second semiconductor chip in the second semiconductor laminate 202 includes a second peripheral circuit unit 250, and the first surface 202a of the second semiconductor laminate is boned to the first surface 101a of the first semiconductor laminate; and first vias 121 which are formed within the first semiconductor laminate 101 and electrically interconnect the first-electrode array 130 and the pixel-driver array 110, specifically, the first-electrode array 130 and electrodes 133 of a pixel driver circuit. The electrodes 133 may act as IO terminals of pixel driver elements in the pixel-driver array 110. The second peripheral circuit unit 250 includes several transistors adapted for a low voltage and a high speed. Since such transistors require a fabrication process different from that for high-voltage, high-current transistors in the pixel driver elements, they are made in distinct chips. This allows less interference and a simpler fabrication process.

In this embodiment, in the first chip containing pixel driver elements and a first peripheral circuit, the pixel driver elements contain transistors that are similar to transistors in the first peripheral circuit in terms of performance. For example, these transistors are all adapted for a low voltage and a low current. The first surface 101a of the first semiconductor laminate is the surface where the transistors are formed, while the second surface 101b is a substrate surface. A second peripheral circuit is formed in the second chip, and the first surface 202a of the second semiconductor laminate is the surface where transistors of the second peripheral circuit are formed, while the second surface 202b is a substrate surface. In order to facilitate wafer processing, the substrates are requires to have a certain thickness under their substrate surfaces, for example, a standard thickness of 725 μm for 8-inch wafers and a standard thickness of 775 μm for 12-inch wafers. Successive bonding at the surfaces with transistors formed thereon is advantageous in device thickness reductions and easier subsequent via formation, as well as in that the substrate surfaces serving as support surfaces can be clamped and hence facilitate manipulations.

In this embodiment, a first interconnect wire 60 and a second via 61 are further included. The first interconnect wire 60 is formed on the second surface 101b of the first semiconductor laminate, and the second via 61 is formed within the first semiconductor laminate 101, electrically interconnecting the first peripheral circuit unit 150 and the first interconnect wire 60.

In this embodiment, a third via 62 is further formed which penetrates through the first semiconductor laminate 101 and terminates within the second semiconductor laminate 202, thereby electrically interconnecting the first interconnect wire 60 and the second peripheral circuit unit 250.

In this embodiment, the substrate surface of the first semiconductor laminate 101 is polished in order to thin the substrate, followed by formation of the second via, the third via and the first interconnect wire on this surface, so that the circuit in the first semiconductor laminate is connected to the circuit in the second semiconductor laminate. This additionally offers the advantages of dispensing with the need for external wiring, significantly reducing the chip area, simplifying the interconnections between the devices, reducing device fabrication cost and remarkably improving the performance.

In the display driver backplane of the present invention, the transistors with considerably different capabilities are distributed in the chips that are stacked together, resulting in less interference and a simpler fabrication process.

Second Embodiment of Display Driver Backplane

Referring to FIG. 2, a description of features in this embodiment that are the same as those in the first embodiment is omitted here for the sake of simplicity and clarity. This embodiment differs from the first embodiment in that, in lieu of the second and third vias, a fourth via 63 is included which penetrates through first semiconductor laminate 101 and terminates within the second semiconductor laminate 202, vertically electrically interconnecting the first peripheral circuit unit 110 and the second peripheral circuit unit 250.

In this embodiment, the fourth via 63 vertically connecting the first peripheral circuit in the first semiconductor laminate and the second peripheral circuit in the second semiconductor laminate allows a simpler configuration of the circuits.

Third Embodiment of Display Driver Backplane

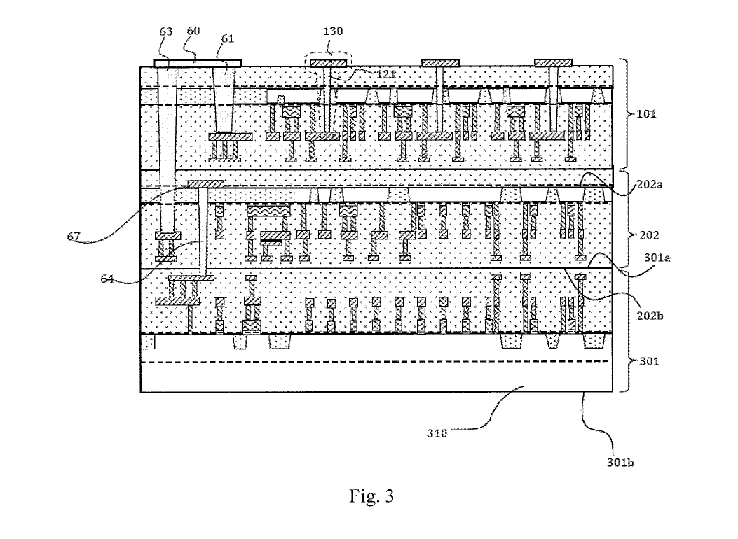

Referring to FIG. 3, a description of features in this embodiment that are the same as those in the first embodiment is omitted here for the sake of simplicity and clarity. This embodiment differs from the first embodiment in further comprising a third semiconductor laminate 301 bonded to the second surface 202b of the second semiconductor laminate. The third semiconductor laminate 301 comprises a first surface 301a and a second surface 301b opposing the first surface. The third semiconductor laminate is bonded to the second surface 202b of the second semiconductor laminate at the first surface 301a. The third semiconductor laminate 301 includes a third chip containing a third peripheral circuit unit 310. In this embodiment, the third peripheral circuit is a memory cell array.

In this embodiment, the bonding is performed in a different manner due to the additionally stacked chip. As the second semiconductor laminate and the third semiconductor laminate are bonded first, the second surface of the second semiconductor laminate is the surface where transistors are formed, while the first surface is a substrate surface.

A fifth via 64 and a second interconnect wire 67 are further included. The second interconnect wire 67 is formed on the first surface 202a of the second semiconductor laminate, and the second interconnect wire is electrically interconnected with the second peripheral circuit in the second semiconductor laminate. The fifth via 64 penetrates through the second semiconductor laminate 202 and terminates within the third semiconductor laminate 301. The second peripheral circuit unit 250 and the third peripheral circuit unit 310 are electrically interconnected via the second interconnect wire.

Each of the first semiconductor laminate, the second semiconductor laminate and the third semiconductor laminate is fabricated from silicon or a silicon compound. The memory cell array is an SRAM, a DRAM or a nonvolatile memory cell array.

First Embodiment of Display Device

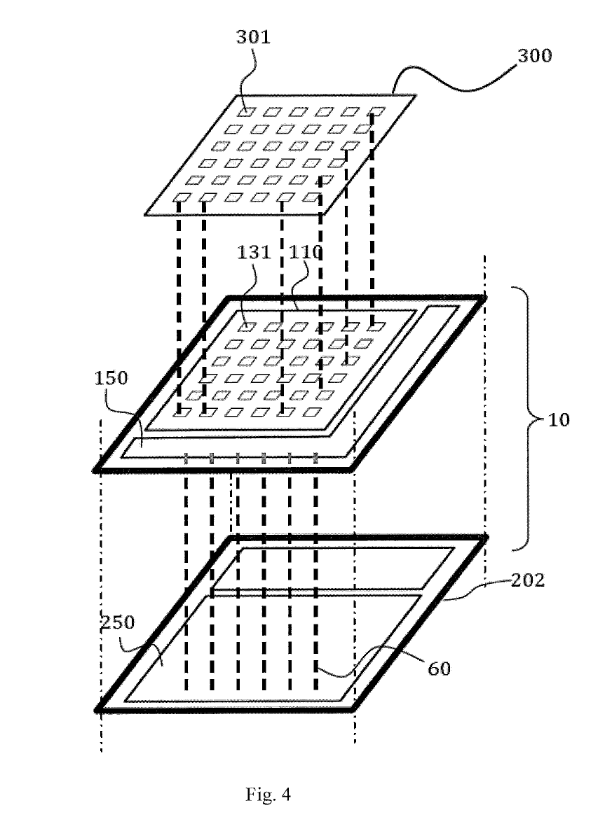

Referring to FIG. 4, a display device comprising a display driver backplane as defined above further includes a display backplane 300 electrically interconnected with the driver backplane. The first-electrode array 110 on the first semiconductor laminate 101 of the display driver backplane 10 is electrically interconnected to a pixel display element array in the display backplane in respective correspondence.

The display backplane includes a light-emitting element array or an optical modulation element array. Specifically, the light-emitting element array may be a light-emitting diode array. The optical modulation element array may be a liquid crystal display element array or an MEMS optical modulation element array.

The first-electrode array 110 may be interconnected with the pixel display element array of the display backplane in such a manner that the pixel display backplane is located on the second surface 101b of the first semiconductor laminate 101 and that the first electrodes in the first-electrode array 110 are directly interconnected with respective corresponding electrodes of pixel display elements 301. Alternatively, the pixel display backplane may be disposed aside the first semiconductor laminate and interconnected therewith by leads.

First Embodiment of Display Driver Backplane Fabrication

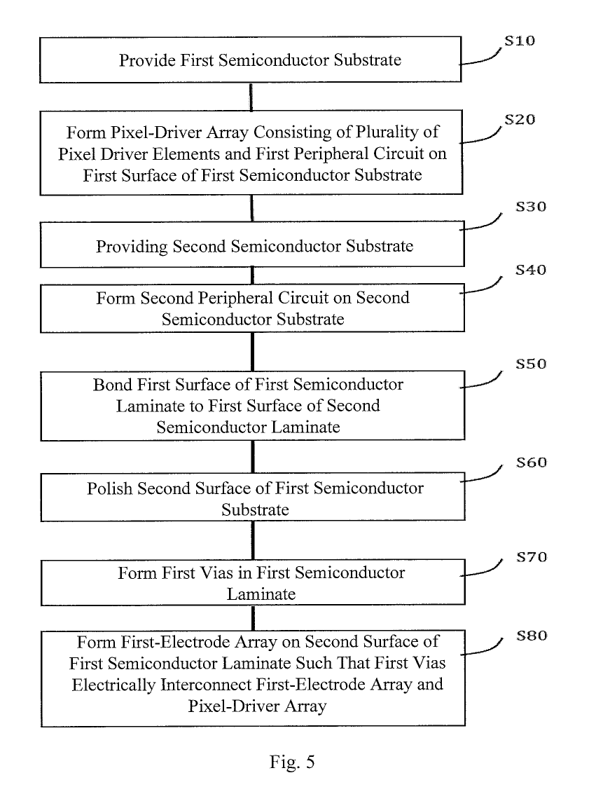

FIG. 5 is a flowchart graphically illustrating a method for fabricating the display device driver backplane according to the first embodiment of the present invention. Referring to FIG. 5, the display device driver backplane is a silicon-based backplane of an LED display device, and the method includes the steps of:

S10: providing a first semiconductor substrate;

S20: forming the pixel-driver array consisting of the plurality of pixel driver elements and the first peripheral circuit on a first surface of the first semiconductor substrate;

S30: providing a second semiconductor substrate;

S40: forming the second peripheral circuit on the second semiconductor substrate;

S50: bonding the first surface of the first semiconductor laminate to the first surface of the second semiconductor laminate;

S60: polishing the second surface of the first semiconductor laminate;

S70: forming the first vias in the first semiconductor laminate; and

S80: forming the first-electrode array on the second surface of the first semiconductor laminate such that the first vias electrically interconnect the first-electrode array and the pixel-driver array.

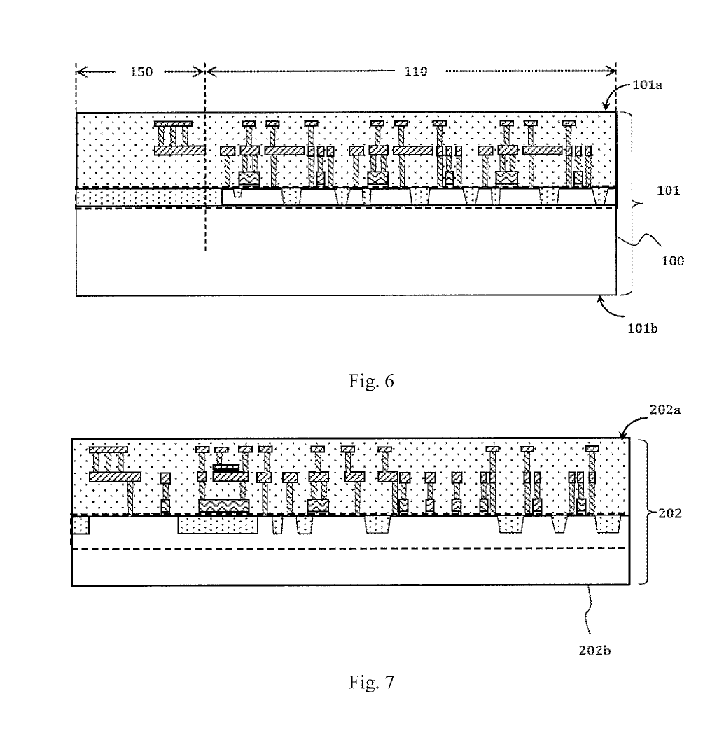

FIGS. 6 to 10 are schematics showing the method for fabricating the display device driver backplane according to the first embodiment of the present invention. Reference is now made to FIGS. 6 to 10 for a detailed description of this first embodiment.

In step S10, with reference to FIG. 6, the first semiconductor substrate 100 is provided. The first semiconductor substrate 100 may be a monocrystalline silicon substrate.

In step 20, with continued reference to FIG. 6, the pixel-driver array 110 of a pixel driver circuit and the first peripheral circuit 150 are formed on the first surface of the semiconductor substrate, resulting in the first semiconductor laminate 101. As such, the pixel-driver array 110 of the pixel driver circuit and the first peripheral circuit 150 are formed on the first surface 101a of the first semiconductor laminate 101, while the second surface 101b of the first semiconductor laminate is a substrate surface. The first semiconductor substrate 100 may be a relatively thick substrate, and the semiconductor laminate may be formed using an existing semiconductor process involving the formation of circuits of MOS transistors. A detailed description of the process is omitted herein. The pixel-driver array of the pixel driver circuit is configured to drive a display panel such as an LED, OLED, liquid crystal display (LCD) panel or a panel of MEMS optical modulators. The MEMS optical modulators may include digital micro-mirror devices and digital switch devices. Therefore, the pixel-driver array 110 of the pixel driver circuit may consist of MOS transistors adapted for a high voltage and a high current. The pixel-driver array may correspond to a pixel display element array such as a light-emitting diode array, wherein pixel driver elements correspond to and drive respective light-emitting diodes. The first peripheral circuit is a circuit configured to receive data and signals or to provide control signals. In this embodiment, a peripheral circuit adapted for a high voltage or a high current may be configured in the first semiconductor laminate, i.e., the same layer as the pixel driver circuit, because they are both made up of high-voltage or high-current transistors and allow easier integration.

In step S30, referring to FIG. 7, a second semiconductor substrate 200 is provided. The second semiconductor substrate 200 may be monocrystalline silicon.

In step S40, with continued reference to FIG. 7, the second peripheral circuit 250 is formed on the second semiconductor substrate, resulting in the second semiconductor laminate 202. This can be done using an existing semiconductor process involving the formation of circuits of MOS transistors, and a detailed description of the process is omitted herein. The second peripheral circuit 250 may be a circuit configured to receive data and signals or to provide control signals, and may be composed of transistors adapted for a low voltage and a high speed. In addition, as the first semiconductor laminate 101 and the second semiconductor laminate 202 are formed in separate layers using different semiconductor processes, they do not interfere with or affect each other. In this embodiment, preferably, the second peripheral circuit is formed on the first surface 202a of the second semiconductor laminate 202, while the second surface 202b of the second semiconductor laminate is a substrate surface beneath which there is a rather large thickness of the semiconductor substrate.

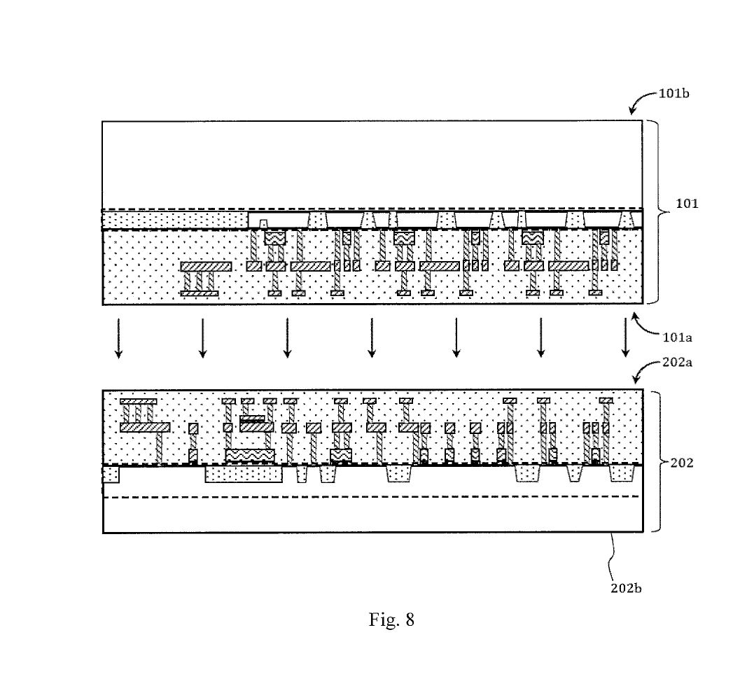

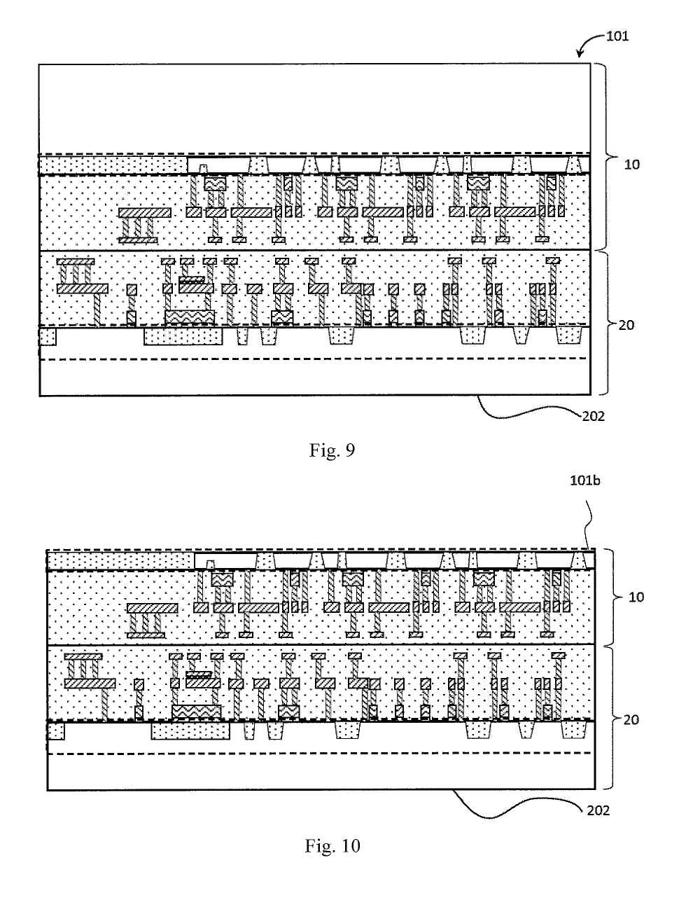

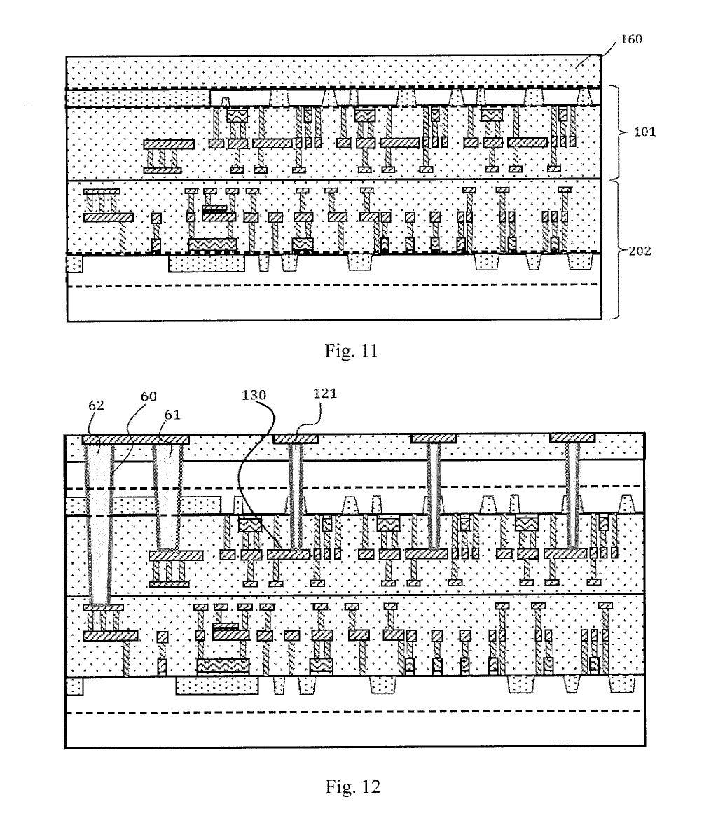

In step S50, referring to FIGS. 8-9, the first surface 101a of the first semiconductor laminate 101 is bonded to the first surface 202a of the second semiconductor laminate 202. The bonding may be accomplished by forming an intermediate dielectric layer such as a silicon dioxide layer on one of the surfaces to be bonded together and then fusing the dielectric layer by heating it. As a result, the second surface 101b of the first semiconductor laminate 101 and the second surface 202b of the second semiconductor laminate 202 are exposed in air, each of which is supported by a rather large thickness of the semiconductor substrate.

In step S60, referring to FIG. 10, the second surface 101b of the first semiconductor laminate 101 is polished. As the second surface 101b of the first semiconductor laminate 101 is supported by the substrate, the second surface 101b of the first semiconductor laminate 101 is polished beneath the support thereof so as to thin the semiconductor substrate to a thickness suitable for etching the vias to expose the circuit. For example, the thickness of the semiconductor substrate may be reduced by 625 μm to 925 μm, so that the thickness is reduced to 5 nm to 10 μm, without causing damage to the devices.

In step S70, with reference to FIGS. 11˜12, the first vias 121 are formed in the first semiconductor laminate 101.

In this preferred embodiment, a dielectric layer 160 is first formed on the second surface 101b of the first semiconductor laminate 101, and the second surface 101b of the first semiconductor laminate 101 is etched with the dielectric layer 160 serving as a protective layer, so that holes exposing the electrodes 133 of the pixel driver circuit are formed in the first semiconductor laminate 101. Subsequently, a metal is filled into the holes to form the first vias 121 and the dielectric layer 160 is removed.

In step S70, with reference to FIGS. 11˜12, the first vias 121 are formed in the first semiconductor laminate 101.

In this embodiment, the step preferably further includes:

forming a second via 61 in the first semiconductor laminate 101. This step may be performed simultaneously with the step of forming the first vias 121. In the same etching step, holes for the first vias 121 and the second via 61 may be simultaneously formed according to adjustment of etching time, followed by deposition of the same metal in the holes in the same deposition step and hence simultaneous formation of the first vias 121 and the second via 61.

Preferably, in this step, a third via 62 is further formed in the same process as the first vias 121 and the second via 61 and penetrates through the first semiconductor laminate 101 and terminates within the second semiconductor laminate 202, thereby electrically interconnecting the first interconnect wire 60 to be formed and second peripheral circuit unit 150.

The first interconnect wire 60 is then formed in the second surface 101b of the first semiconductor laminate 101. This step can be carried out in such a manner that a mask layer is first formed and a metal layer is then deposited, thereby forming the first interconnect wire 60. The second via 61 electrically interconnects the first peripheral circuit unit 150 and the first interconnect wire 60. In this embodiment, this step is performed concurrently with step S80.

In step S80, the first-electrode array 130 is formed in the area of the first surface 101a of the first semiconductor laminate 101 where the first vias 121 are formed, such that the array of first vias 121 electrically interconnect the first-electrode array 130 and the pixel-driver array 110. Specifically, the first vias interconnect the first electrodes with the respective corresponding pixel driver elements.

Preferably, this step further includes the formation of the first interconnect wire 60.

Second Embodiment of Display Driver Backplane Fabrication Method

Similar to the fabrication method of the display driver backplane of the first embodiment, a method according to this embodiment also includes the steps of:

S10: providing a first semiconductor substrate;

S20: forming the pixel-driver array consisting of the plurality of pixel driver elements and the first peripheral circuit on a first surface of the first semiconductor substrate;

S30: providing a second semiconductor substrate;

S40: forming the second peripheral circuit on the second semiconductor substrate;

S50: bonding the first surface of the first semiconductor laminate to the first surface of the second semiconductor laminate;

S60: polishing the second surface of the first semiconductor laminate;

S70: forming the first vias in the first semiconductor laminate; and

S80: forming the first-electrode array on the second surface of the first semiconductor laminate such that the first vias electrically interconnect the first-electrode array and the pixel-driver array.

Their difference lies in that:

referring to FIG. 2, further including the step of: forming a fourth via 63 that penetrates through first semiconductor laminate 101 and terminates within the second semiconductor laminate 202, thereby vertically electrically interconnecting the first peripheral circuit unit 150 and the second peripheral circuit unit 250.

Specifically, in S70, the first semiconductor laminate 101 is etched concurrently with the formation of the first vias, exposing the first peripheral circuit 150 in the first semiconductor laminate 101. The etching continues until the first semiconductor laminate 101 is penetrated and ends within the second semiconductor laminate 202, so that a hole exposing the second peripheral circuit 250 in the second semiconductor laminate 202 is formed. After that, a metal is filled into the holes formed by the etching so that the first peripheral circuit 150 is electrically interconnected with the second peripheral circuit 250. Lastly, the first interconnect wire 60 in communication with the fourth via 63 is formed in the second surface 101b of the first semiconductor laminate 101. Reference can be made to the above embodiment for details in the formation of the first interconnect wire and a repeated description thereof is omitted.

Third Embodiment of Display Driver Backplane Fabrication Method

Similar to the fabrication method of the first embodiment, a method according to this embodiment also includes the steps of:

S10: providing a first semiconductor substrate;

S20: forming the pixel-driver array consisting of the plurality of pixel driver elements and the first peripheral circuit on a first surface of the first semiconductor substrate;

S30: providing a second semiconductor substrate; and

S40: forming the second peripheral circuit on the second semiconductor substrate.

In this embodiment, the second peripheral circuit is formed in the second surface 202b of the second semiconductor laminate 202, while the first surface 202a of the second semiconductor laminate is a substrate surface beneath which there is a rather large thickness of the semiconductor substrate.

Referring to FIG. 3, are further included, after these steps, the steps of:

providing a third semiconductor substrate 30 having a first surface and a second surface opposing the first surface;

forming the third peripheral circuit 310 on the first surface of the third semiconductor substrate 30, resulting in the third semiconductor laminate 301;

bonding the first surface 301a of the third semiconductor laminate 301 to the second surface 202b of the second semiconductor laminate 202;

polishing the first surface 202a of the second semiconductor laminate 202 to thin the semiconductor substrate; and

forming the fifth via 64 which penetrates through the second semiconductor laminate 202 and connects the third peripheral circuit. Reference can be made to the passages describing the formation of the second via in the above embodiment for information about the formation of the fifth via, and a description thereof is omitted.

The second interconnect wire 67 is then formed in the area of the first surface 202a of the second semiconductor laminate 202 where the fifth via 64 is formed. The fifth via 64 electrically interconnects the third peripheral circuit 310 and the second interconnect wire 67. Reference can be made to the passages describing the formation of the first-electrode array in the above embodiment for information about the formation of the second interconnect wire 67, and a description thereof is omitted.

S50: bonding the first surface of the first semiconductor laminate to the first surface of the second semiconductor laminate;

S60: polishing the second surface of the first semiconductor laminate;

S70: forming the first vias in the first semiconductor laminate; and

S80: forming the first-electrode array on the second surface of the first semiconductor laminate such that the first vias electrically interconnect the first-electrode array and the pixel-driver array.

It is apparent that those skilled in the art can make various changes and modifications to the present invention without departing from the spirit and scope thereof. Accordingly, the present invention is intended to embrace such changes and modifications if they fall within the scope of the appended claims and the equivalents thereof.

What is claimed is:

1. A display driver backplane, comprising:
a first semiconductor laminate, comprising a first surface and a second surface opposing the first surface, wherein the first semiconductor laminate comprises a first semiconductor chip including: a pixel-driver array consisting of a plurality of pixel driver elements; and a first peripheral circuit unit for driving the pixel-driver array;
a first-electrode array consisting of a plurality of first electrodes formed on the second surface of the first semiconductor laminate, wherein each of the plurality of first electrodes in the first-electrode array is connected to a corresponding one of the plurality of pixel driver elements in the pixel-driver array through at least one first via, and wherein the first-electrode array is connected to an external pixel display element array; and
a second semiconductor laminate, comprising a first surface and a second surface opposing the first surface, wherein the second semiconductor laminate comprises a second semiconductor chip including: a second peripheral circuit unit, and wherein the first surface of the second semiconductor laminate is bonded to the first surface of the first semiconductor laminate.

2. The display driver backplane according to claim 1, further comprising a first interconnect wire and a second via, wherein the first interconnect wire is arranged on the second surface of the first semiconductor laminate, and wherein the second via is provided in the first semiconductor laminate to electrically interconnect the first peripheral circuit unit and the first interconnect wire.

3. The display driver backplane according to claim 1, further comprising a third via which penetrates through the first semiconductor laminate and terminates within the second semiconductor laminate for electrically interconnecting the first interconnect wire and the second peripheral circuit unit.

4. The display driver backplane according to claim 1, further comprising a fourth via which penetrates through the first semiconductor laminate and terminates within the second semiconductor laminate for vertically electrically interconnecting the first peripheral circuit unit and the second peripheral circuit unit.

5. The display driver backplane according to claim 1, further comprising a third semiconductor laminate bonded to the second surface of the second semiconductor laminate, the third semiconductor laminate comprising a first surface and a second surface opposing the first surface, the first surface of the third semiconductor laminate being bonded to the second surface of the second semiconductor laminate, the third semiconductor laminate comprising a third semiconductor chip, the third semiconductor chip comprising a third peripheral circuit unit.

6. The display driver backplane according to claim 5, further comprising a fifth via and a second interconnect wire, wherein the second interconnect wire is arranged on the first surface of the second semiconductor laminate, and wherein the fifth via penetrates through the second semiconductor laminate and terminates within the third semiconductor laminate for electrically interconnecting the second peripheral circuit unit and the third peripheral circuit unit.

7. The display driver backplane according to claim 5, wherein each of the first semiconductor laminate, the second semiconductor laminate and the third semiconductor laminate is fabricated from silicon or a silicon compound.

8. The display driver backplane according to claim 5, wherein the second peripheral circuit unit or the third peripheral circuit unit comprises an array of memory cells.

9. The display driver backplane according to claim 8, wherein the array of memory cells consists of SRAM, DRAM or nonvolatile memory cells.

10. A display device comprising a display driver backplane according to any one of claim 1, wherein the display device further comprises a display backplane electrically interconnected with the driver backplane, wherein the display backplane comprises a pixel display element array, and wherein the first-electrode array on the first semiconductor laminate of the display driver backplane is electrically interconnected with the pixel display element array of the display backplane.

11. The display device according to claim 10, wherein the pixel display element array is a light-emitting element array or an optical modulation element array.

12. The display device according to claim 11, wherein the light-emitting element array is a light-emitting diode array.

13. The display device according to claim 11, wherein the optical modulation element array is a liquid crystal display element array or an MEMS optical modulation element array.

14. A method for fabricating the display driver backplane according to claim 1, comprising the steps of:
providing a first semiconductor substrate comprising a first surface and a second surface opposing the first surface;
forming the pixel-driver array consisting of the plurality of pixel driver elements and the first peripheral circuit unit on the first semiconductor substrate, resulting in the first semiconductor laminate;
providing a second semiconductor substrate comprising a first surface and a second surface opposing the first surface;
forming the second peripheral circuit on the second semiconductor substrate, resulting in the second semiconductor laminate;
bonding the first surface of the first semiconductor laminate to the first surface of the second semiconductor laminate;
polishing the second surface of the first semiconductor substrate to thin the semiconductor laminate;
forming the plurality of first vias in the first semiconductor laminate; and
forming the first-electrode array on the second surface of the first semiconductor laminate such that each of the plurality of first vias electrically interconnects one of the plurality of first electrodes in the first-electrode array and a corresponding one of the plurality of pixel driver elements in the pixel-driver array.

15. The method for fabricating the display driver backplane according to claim 14, further comprising the steps of:
forming a second via in the first semiconductor laminate; and
forming a first interconnect wire on the second surface of the first semiconductor laminate;
wherein the second via electrically interconnects the first peripheral circuit unit and the first interconnect wire.

16. The method for fabricating the display driver backplane according to claim 15, further comprising the steps of:
forming a third via which penetrates through the first semiconductor laminate and terminates within the second semiconductor laminate for electrically interconnecting the first interconnect wire and the second peripheral circuit unit.

17. The method for fabricating the display driver backplane according to claim 14, further comprising the steps of:
forming a fourth via which penetrates through the first semiconductor laminate and terminates within the second semiconductor laminate for vertically electrically interconnecting the first peripheral circuit unit and the second peripheral circuit unit.

18. The method for fabricating the display driver backplane according to claim 14, wherein
the second peripheral circuit is formed on the first surface of the second semiconductor substrate.

19. The method for fabricating the display driver backplane according to claim 14, further comprising, prior to bonding the first semiconductor laminate to the second semiconductor laminate, the steps of:
providing a third semiconductor substrate comprising a first surface and a second surface opposing the first surface;
forming a third peripheral circuit unit on the first surface of the third semiconductor substrate, resulting in a third semiconductor laminate;
bonding the first surface of the third semiconductor laminate to the second surface of the second semiconductor laminate;
polishing the first surface of the second semiconductor substrate;
forming a fifth via which penetrates through the second semiconductor laminate; and
forming a second interconnect wire on the first surface of the second semiconductor laminate such that the fifth via electrically interconnects the third peripheral circuit and the second interconnect wire.

20. The method for fabricating the display driver backplane according to claim 19, wherein the second peripheral circuit unit is formed on the second surface of the second semiconductor laminate.
